(19) United States
(12) Patent Application Publication
(10) Pub. No.: US 2014/0371971 A1
(43) Pub. Date: Dec. 18, 2014

(54) SINGLE WHEEL IRRIGATION TOWER

(71) Applicant: Lindsay Corporation, Omaha, NE (US)

(72) Inventor: Dick Philip Welch, Elkhorn, NE (US)

(21) Appl. No.: 13/920,997

(22) Filed: Jun. 18, 2013

(51) Int. Cl. A01G 25/09

(52) U.S. Cl. CPC A01G 25/09
USPC 701/23

(57) ABSTRACT

A single wheel irrigation tower for use in an irrigation system, the tower comprising a support member, a single wheel rotatably connected to the support member for moving along a ground surface, a motor operable to rotate and propel the wheel along the ground surface, and a sensor and controller collectively operable to balance the support member on the wheel.

### BACKGROUND OF THE INVENTION

1. Field of the Invention

Embodiments of the current invention relate to irrigation systems. More particularly, embodiments of the current invention relate to an improved irrigation tower for use in a movable irrigation system.

2. Description of the Related Art

Irrigation towers are used in many types of irrigation systems to support pipe spans or other structures for distributing irrigation liquids across a field. The towers are typically movable to maximize an area of distribution. A conventional tower supports its span with a triangular frame having at least two wheels rotatably coupled thereto. The resulting structure is designed so that its center of gravity is contained between the two wheels, thereby preventing the structure from tipping over.

However, this multi-wheel tower design has a few drawbacks. For example, because each wheel supports a substantial amount of weight of the structure, each wheel must be powered, either by a common motor or separate motors, to prevent the wheels from getting stuck or “spinning out.” The wheels must also have dedicated gearboxes, further complicating design and increasing cost. Also, because the towers rarely follow a completely linear path, the trailing wheel often does not traverse the same path as the leading wheel, causing additional tire scrub on the field. Additionally, complex maneuvers are more difficult or impossible because the towers cannot turn sharply or move sideways.

Accordingly there is a need for an improved irrigation tower that overcomes the above-described limitations.

### SUMMARY OF THE INVENTION

Embodiments of the current invention solve the above-mentioned problems and provide a distinct advance in the art of irrigation towers. More particularly, embodiments of the invention provide an improved irrigation tower with a single wheel assembly that is easier to steer and that causes less tire scrub on the field.

One embodiment of the single wheel irrigation tower comprises a support member; a single wheel rotatably connected to the support member for moving along a ground surface; a motor operable to rotate and propel the wheel along the ground surface; a sensor operable to detect an orientation of the support member; and a controller. The controller is operable to receive data representative of the orientation from the sensor, apply a balancing algorithm to the data, and generate an output. The output is representative of a maneuver necessary to maintain a balance of the support member on the wheel. The controller is further configured to transmit an instruction to the motor to rotate the wheel for a direction, duration, and speed corresponding to the output for maintaining the balance of the support member on the wheel.

Embodiments of the single wheel irrigation tower provide numerous advantages over conventional two wheel irrigation towers. For example, having a single wheel eliminates the need for multiple drive motors and power transfer components. Tire scrub left on the field is reduced over multi-wheel towers. Also, complex maneuvers are greatly simplified with a single wheel irrigation tower.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a perspective view of an exemplary irrigation system including a plurality of single wheel irrigation towers constructed in accordance with embodiments of the invention;

FIG. 2 is a perspective view of one of the single wheel irrigation towers of FIG. 1;

FIG. 3 is a perspective view of a single wheel irrigation tower including a steerable link steerably connected to the wheel and an auxiliary wheel for use in a power down mode in accordance with an embodiment of the invention;

FIG. 4 is a perspective view of a single wheel irrigation tower including an auxiliary wheel for supporting the support member in a power down mode in accordance with an embodiment of the invention;

FIG. 5 is an elevation view of the single wheel irrigation tower in FIG. 4 showing the auxiliary wheel spaced slightly from the ground in a power on mode in accordance with an embodiment of the invention; and

FIG. 6 is an elevation view of a single wheel irrigation tower including two outriggers for supporting the support member in a power down mode in accordance with an embodiment of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. It will be understood that elements can be duplicated, rearranged, or reoriented, such as utilizing multiple sensors where only one is described, without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

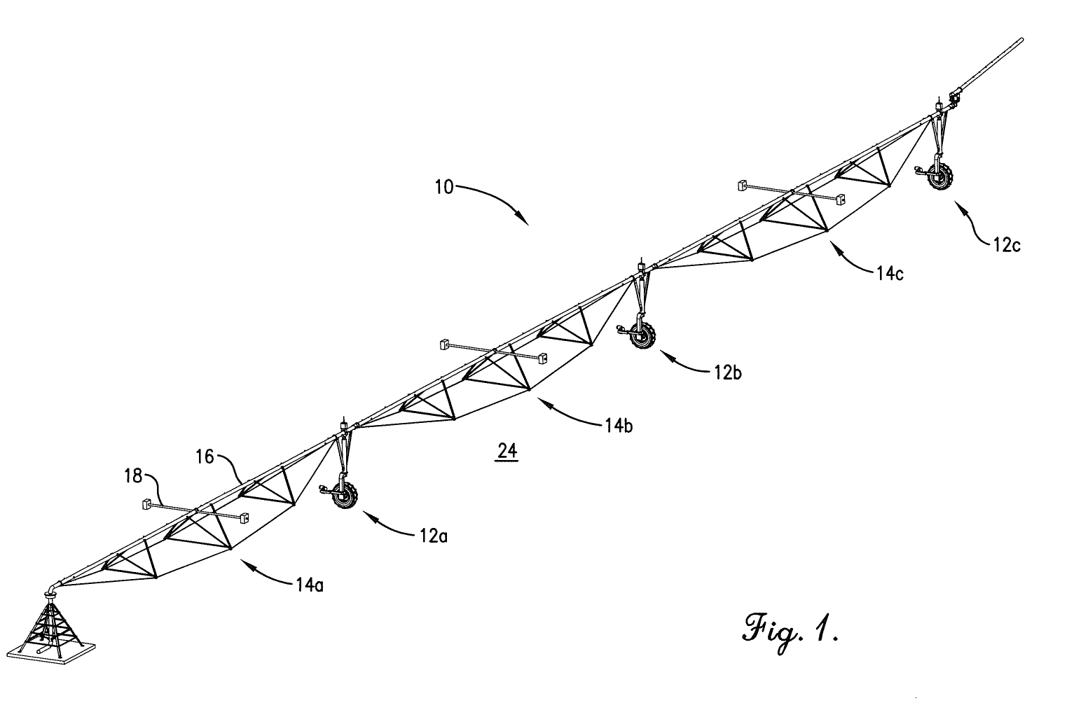

Turning now to the drawing figures, and initially FIG. 1, an irrigation system 10 is shown including a plurality of single wheel irrigation towers 12a, 12b, 12c. The illustrated irrigation system 10 is a center pivot system but the principles of the present invention are also applicable to linear or lateral move irrigation systems and other types of moveable irrigation systems. The irrigation system 10 has a plurality of irrigation spans 14a, 14b, 14c each including a conduit 16 for distributing an irrigation fluid such as water or pesticide and operable to provide structure and spacing to the irrigation system 10. The ends of the irrigation spans 14a-c are coupled to and supported by the single wheel irrigation towers 12a-c. The irrigation spans 14a-c are pivotably linked to each other at the single wheel irrigation towers 12a-c so that the irrigation spans 14a-c can take complex paths and so that the irrigation system 10 can flexibly traverse obstacles and complex terrain. The irrigation spans 14a-c may also each include a balance structure 18 operable to increase inertia thereof, for improving the balance of the single wheel irrigation towers 12a-c. Although the illustrated irrigation system 10 is shown with three irrigation towers 12a-c and three spans 14a-c, it may include any number of such towers and spans.

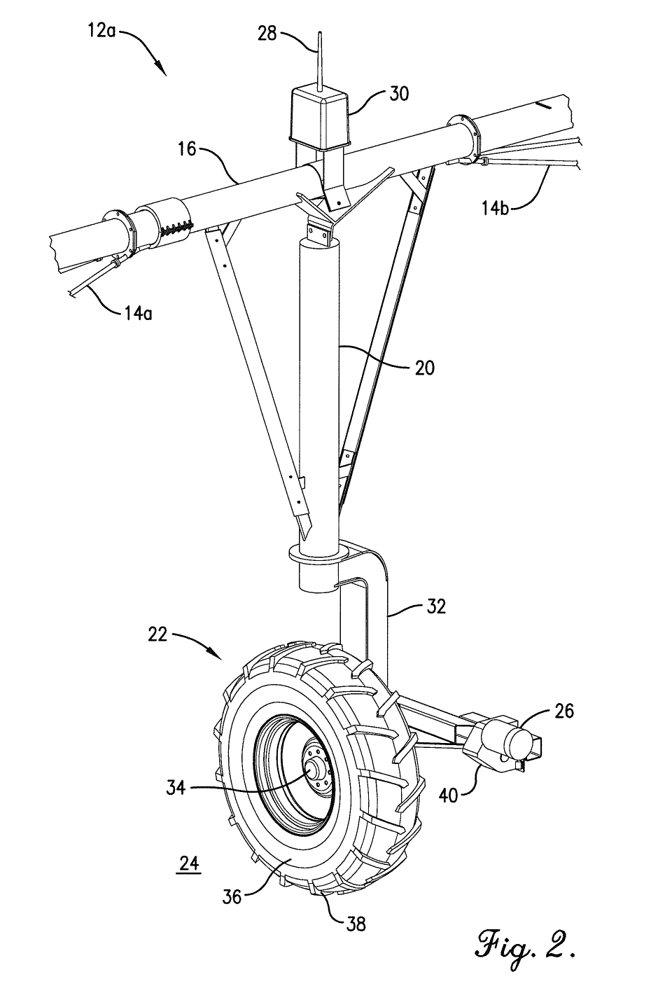

The irrigation towers 12a-c are essentially identical, so only one of them, irrigation tower 12a, will be described in detail. The single wheel irrigation tower 12a comprises a support member 20, a single wheel 22 rotatably connected to the support member 20 for moving along a ground surface 24, a motor 26 operable to rotate and propel the wheel 22 along the ground surface 24, a sensor 28 operable to detect an orientation of the support member 20, and a controller 30 operable to receive signal, perform algorithms on the signals, generate outputs based on the algorithms, and instruct components of the irrigation tower 12a to perform tasks or maneuvers (FIG. 2).

The support member 20 may be several feet to several yards tall, and may be several inches to a few feet wide. The support member 20 may be cylindrical, square, rectangular, or other shape, and may be solid or hollow. The support member 20 may be formed of any material such as plastic, wood, or metal with sufficient strength to support the irrigation spans 14a,b. The support member 20 is shown generally vertically aligned above the center of the wheel 22, but may be offset instead. The support member 20 includes a bracket arm 32 or other connector and an axle 34 rotatably coupled to the bracket arm 32 for connecting to the wheel 22. Because the support member 20 is aligned directly above the wheel 22, the bracket arm 32 is L-shaped and extends horizontally to accommodate the wheel 22. Alternatively, the support member 20 may be offset from the wheel 22 and may extend downward directly to the axle 34, obviating the need for the bracket arm 32. The support member 20 is coupled to the irrigation spans 14a,b, provides support thereto, and spaces the spans 14a,b from the ground surface 24.

The wheel 22 supports the support member 20 above the ground surface 24. The wheel 22 is coupled to the axle 34 and is rotatable about a horizontal axis and with respect to the support member 20. The wheel 22 is operable to roll along the ground surface 24 and may include a tire 36, typically formed of rubber, with treads 38 for more effectively rolling over dirt, mud, and debris. The tire 36 may be pneumatic or solid. Solid tires (i.e. “flat free” tires) are beneficial in that they will not lose air pressure if punctured.

Alternatively, the wheel 22 may be part of a track system including a cog spaced in front of or behind the wheel 22 and a closed-loop track disposed around the wheel 22 and cog. The cog may be a gear, sprocket, wheel, bearing, pulley, or other rotatable component operable to guide and engage the track. The track may be a belt, band, or plurality of links. The track may include at least one longitudinal groove, contour, or protrusion along an interior side for maintaining an alignment on the wheel 22 and cog, and may include latitudinal grooves, contours, protrusions, or holes operable to engage complementary grooves, contours, protrusions, or holes on the wheel 22 and/or cog for more effectively transferring power from the wheel 22 to the track and reducing slip therebetween. The track may also include treads along an exterior side for more effectively traversing dirt, mud, and debris.

The motor 26 is mechanically coupled to the wheel 22 and is operable to exert angular forces on the wheel 22, causing the wheel 22 to rotate and roll along the ground surface 24. The motor 26 may be coupled to the wheel 22 directly or via a power train 40, which may include any number of components such as a belt, chain, gear, drive shaft, transmission, and pneumatics and hydraulics. The power train 40 may provide a gear reduction that enables the motor 26 to spin faster than, and to exert a higher output torque on, the wheel 22. The motor 26 may be variable speed, wherein the motor 26 changes speed to effect a change in wheel speed or direction, or may be single speed, wherein the motor 26 spins at a constant speed and a variable transmission such as a hydraulic swash plate pump or variable v-belt sheave and pulley system causes the wheel 22 to change speed. The motor 26 may be electric or gas powered, or may derive its power from water pressure of the irrigation system 10. The motor 26, or alternatively, the variable transmission, is communicatively connected to and receives instructions from the controller 30 to rotate the wheel 22.

The sensor 28 is communicatively coupled to the controller 30 and is configured to generate a reading of an orientation, change in orientation, acceleration, wind speed, or other balancing information of the support member 20 or other portion of the single wheel irrigation tower 12a. The sensor 28 may be a gyroscope, accelerometer, magnetic sensor, motion sensor, or wind speed sensor and communicates data representative of the balancing information to the controller 30. The sensor 28 may make hundreds or even thousands of readings per second, and may only communicate a reading if the present reading is different than the previous reading. Multiple sensors may be employed to provide readings along multiple axes, more accurate readings, or more diverse readings such as a pitch reading and a wind speed reading.

The controller 30 is communicatively coupled to the sensor 28 and the motor 26. The controller 30 receives the readings from the sensor 28, applies a balancing algorithm to the readings, generates an output signal based on the readings and the algorithm, and instructs the motor 26 to perform an action by transmitting the output signal thereto. The controller 30 may include any number of electronic and computational components such as microchips, integrated circuits, logic switches, memories, processors, computers, hardware, firmware, and software. The controller 30 may additionally be communicatively coupled to controllers of other single wheel towers in the irrigation system 10 to cooperatively balance the single wheel irrigation tower 12a. The controller 30 may additionally be communicatively coupled to a second motor for actuating a steerable link, and may further be communicatively coupled to a global navigation satellite system (GNSS) for receiving positional data, both described below.

Embodiments of the present invention may also comprise one or more computer programs stored in or on computer-readable medium residing on or accessible by the controller 30. The computer programs may comprise listings of executable instructions for implementing logic functions and can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, a portable compact disc read-only memory (CDROM), and “cloud” based servers.

In another embodiment of the invention illustrated in FIG. 3, the single wheel irrigation tower 12a further includes a steerable link 42 and a steering motor 44 including an actuator arm 46 drivably coupled to the steerable link 42 for orienting the wheel in a new direction. The steerable link 42 is pivotably coupled to the steering motor 44 near a first end and pivotably coupled to the bracket arm 32 near a second end. The steerable link 42 has suitable geometry to provide enough torque and a wide enough range of motion to the wheel 22 for performing complex maneuvers. The steerable link 42, steering motor 44, and actuator arm 46 are collectively configured to transmit a turning force to the wheel 22, thereby orienting the wheel 22 in a new direction. The steering motor 44 may include power train components such as a belt, chain, gear, transmission, and pneumatics and hydraulics for providing a gear reduction that enables the steering motor 44 to turn faster than and exert a higher output torque on the wheel 22. The steering motor 44 may be variable speed, wherein the steering motor 44 changes speed to effect a change in wheel speed or direction, or may be single speed, wherein the steering motor 44 spins at a constant speed and a variable transmission such as a hydraulic swash plate pump or variable v-belt sheave and pulley system causes the wheel 22 to turn at a different speed. The steering motor 44 may be electric or gas powered, or may derive its power from water pressure of the irrigation system 10. The steering motor 44, or alternatively, the variable transmission, is communicatively connected to and receives instructions from the controller 30 to turn the wheel 22.

Because the irrigation tower 12a lacks a trailing wheel, the wheel 22 is operable to make sharp turns. Whereas plotting a new course with conventional towers requires performing a large number of maneuvers in sequence, or a single maneuver over the course of a large path, plotting a new course with the single wheel irrigation tower 12a requires simply turning the wheel 22 in the new direction.

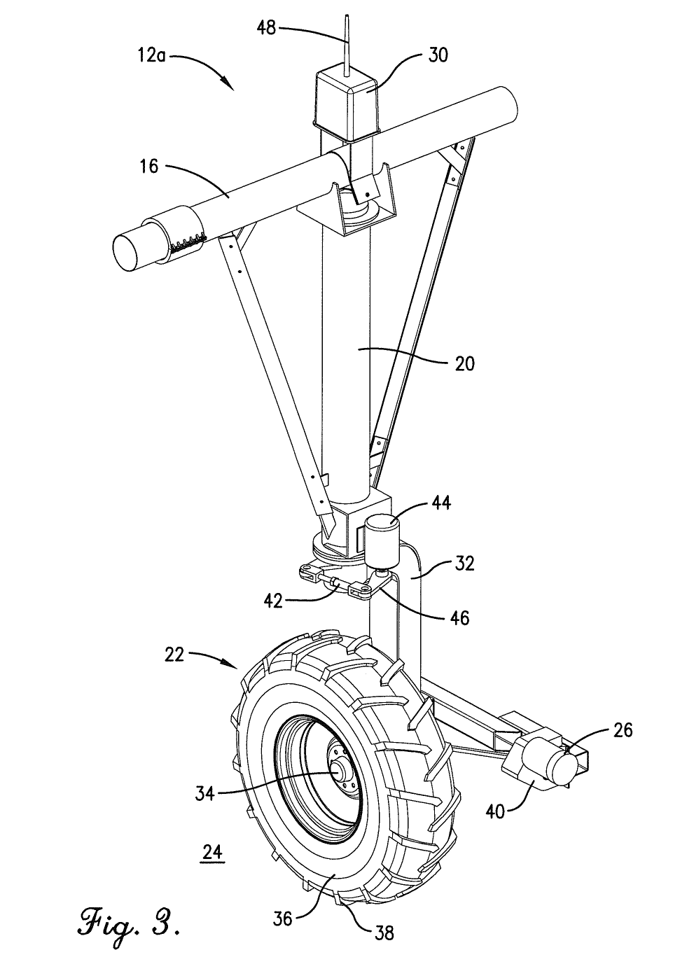

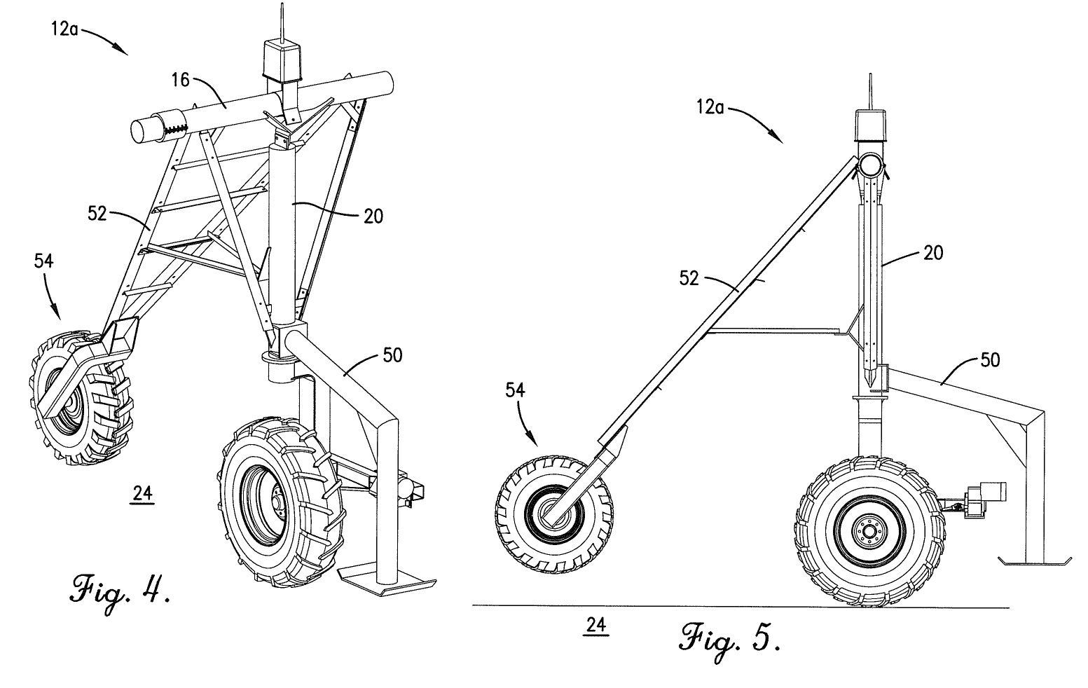

In another embodiment illustrated in FIGS. 4 and 5, the single wheel irrigation tower 12a further includes a GNSS (Global Navigation Satellite System) receiver 48 for receiving positional data from a GNSS. The receiver 48 is communicatively coupled to the controller 30 for sending the positional data thereto. The controller 30 obtains the positional data from the receiver 48, applies a maneuver algorithm to the positional data, generates an output signal based on the data and algorithm, and instructs the motors 26, 44 to perform an action by transmitting the output signal thereto.

In another embodiment, the single wheel irrigation tower 12a includes an auxiliary support member 50 coupled to and partially spaced from the support member 20 near a lower end, and optionally includes an auxiliary wheel 52 rotatably coupled to the auxiliary support member 50, spaced from the wheel 22, and vertically spaced from the ground surface 24 when the single wheel irrigation tower 12a is in a power on mode (FIGS. 4 and 5). The auxiliary wheel 52 is operable to engage the ground surface 24 when the single wheel irrigation tower 12a is in a power loss, power down, maintenance, or transport mode.

In yet another embodiment, the single wheel irrigation tower 12a includes two outriggers 54, 56 coupled to and partially spaced from the support member 20 near a lower end and vertically spaced from the ground surface 24 when the single wheel irrigation tower 12a is in a power on mode (FIG. 6). The outriggers 54, 56 are operable to engage the ground surface 24 when the single wheel irrigation tower 12a is in a power loss, power down, maintenance, or transport mode.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An irrigation tower for use in a movable irrigation system, the irrigation tower comprising:
a support member;
a single wheel rotatably connected to the support member for moving along a ground surface;
a motor operable to rotate and propel the wheel along the ground surface;
at least one sensor operable to detect an orientation of the support member; and
a controller operable to receive data representative of the orientation from the sensor, apply a balancing algorithm to the data, and generate an output, the output being representative of a maneuver necessary to maintain a balance of the support member on the wheel, the controller being further configured to transmit an instruction to the motor to rotate the wheel for a direction, duration, and/or speed corresponding to the output for maintaining the balance of the support member on the wheel.

2. The irrigation tower of claim 1, further comprising at least one auxiliary member coupled with the support member for providing additional support for the tower when the tower is in a power off mode.

3. The irrigation tower of claim 2, further comprising an auxiliary wheel rotatably connected to the auxiliary member, the auxiliary wheel being configured to be in contact with the ground surface only when the tower is in a power off mode.

4. The irrigation tower of claim 1, further comprising a second sensor for detecting a wind velocity, wherein the controller is further configured to receive data representative of the wind velocity from the second sensor and apply the balancing algorithm to the data representative of the wind velocity so that the output from the controller and the instruction delivered to the motor account for wind effects.

5. The irrigation tower of claim 1, wherein the controller is operable to communicate with a controller of a second irrigation tower for cooperatively maintaining the balance of the support member on the wheel.

6. The irrigation tower of claim 1, wherein the sensor is positioned directly above a center of the wheel.

7. The irrigation tower of claim 1, wherein the sensor is operable to periodically detect the orientation, and the controller is operable to periodically receive the data representative of the orientation from the sensor, apply the balancing algorithm to the data, generate the output, and transmit the instruction to the motor at least once every one-hundredth of a second.

8. The irrigation tower of claim 1, wherein the wheel defines a line of travel, and the tower further comprises at least one cog spaced from the wheel in the line of travel and a closed-loop track disposed around the wheel and the sprocket, the wheel being operable to drivably advance the track along the ground surface in the line of travel.

9. An irrigation tower for use in a movable irrigation system, the irrigation tower comprising:
a support member;
a single wheel rotatably connected to the support member for moving along a ground surface;
a steerable link connected to the wheel for orienting the wheel in a new horizontal direction;
a motor operable to rotate and propel the wheel along the ground;
at least one sensor operable to detect an orientation of the support member; and
a controller operable to receive data representative of the orientation from the sensor, apply a balancing algorithm to the data, and generate an output, the output being representative of a maneuver necessary to maintain a balance of the support member on the wheel, the controller being further configured to transmit an instruction to the motor to rotate the wheel for a direction, duration, and/or speed corresponding to the output for maintaining the balance of the support member on the wheel.

10. The irrigation tower of claim 9, wherein the motor is further operable to actuate the steerable link.

11. The irrigation tower of claim 10, further comprising a power transmission system for managing power generated by the motor and transmitted to the steerable link and the wheel.

12. The irrigation tower of claim 11, wherein the controller is operable to transmit an instruction to the power transmission system to adjust the power transmitted to the steerable link and/or the wheel corresponding to the output.

13. The irrigation tower of claim 9, further comprising a steering motor operable to actuate the steerable link.

14. The irrigation tower of claim 13, wherein the controller is further operable to transmit an instruction to the steering motor to actuate the steerable link.

15. An irrigation system comprising:
an irrigation source;
at least one irrigation span coupled to the irrigation source and movable at a first end, the irrigation span being operable to distribute an irrigation liquid; and
a movable tower supporting and coupled to the irrigation span at the first end, the tower comprising:
a support member;
a single wheel rotatably connected to the support member for moving along a ground surface;
a motor operable to rotate and propel the wheel along the ground surface;
at least one sensor operable to detect an orientation of the support member; and
a controller operable to receive data representative of the orientation from the sensor, apply a balancing algorithm to the data, and generate an output, the output being representative of a maneuver necessary to maintain a balance of the support member on the wheel, the controller being further configured to transmit an instruction to the motor to rotate the wheel for a direction, duration and/or speed corresponding to the output for maintaining the balance of the support member on the wheel.

16. The irrigation system of claim 15, wherein the span includes a structure for improving the balance of the support member on the wheel.

17. The irrigation system of claim 15, further comprising a second tower supporting and coupled to the irrigation span at a second end spaced from the first end, the second tower comprising:
a support member;
a single wheel rotatably connected to the support member for moving along the ground surface;
a motor operable to rotate and propel the wheel along the ground surface;
a sensor operable to detect an orientation of the support member; and
a controller operable to receive data representative of the orientation of the support member from the sensor, apply a balancing algorithm to the data, and generate an output, the output being representative of a maneuver necessary to maintain a balance of the support member on the wheel, the controller being further configured to transmit an instruction to the motor to rotate the wheel for a direction, duration, and/or speed corresponding to the output for maintaining the balance of the support member on the wheel.

18. The irrigation system of claim 17, wherein the controllers of the first and second towers are communicatively coupled to each other and are collectively operable to maintain the balance of the support members.

19. The irrigation system of claim 17, communicatively coupled to a global navigation satellite system (GNSS), wherein the towers are collectively configured to align themselves with respect to each other according to an alignment algorithm and positional data received from the GNSS.

20. The irrigation system of claim 17, communicatively coupled to a global navigation satellite system (GNSS), wherein the towers are collectively configured to follow predetermined paths according to a trajectory algorithm and positional data received from the GNSS.
